(19) United States
(12) Patent Application Publication
(10) Pub. No.: US 2023/0062174 A1
(43) Pub. Date: Mar. 2, 2023

(54) COOLING DEVICE FOR COOLING A BATTERY CELL STACK, AND BATTERY SYSTEM

(71) Applicant: Robert Bosch GmbH, Stuttgart (DE)

(72) Inventor: Markus Schmitt, Tamm (DE)

(21) Appl. No.: 17/893,766

(22) Filed: Aug. 23, 2022

(30) Foreign Application Priority Data
Aug. 25, 2021 (DE) 102021209304.3

(51) Int. Cl. H01M 10/6556; H01M 10/613; H01M 50/204

(52) U.S. Cl. CPC H01M 10/6556; H01M 10/613; H01M 50/204

(57) ABSTRACT

A cooling device (10) for cooling a battery cell stack (100) having a plurality of battery cells (110), the cooling device (10) having an inlet port (20) for inflow of a cooling medium (K) into the cooling device (10), an outlet port (30) for outflow of the cooling medium (K) from the cooling device (10), and at least one cooling channel (40), wherein the cooling channel (40) is arranged in the flow path of the cooling medium (K) between the inlet port (20) and the outlet port (30), wherein at least two flow inserts (50) are arranged in the cooling channel (40), and the at least two flow inserts (50) are of modular and planar design. The invention also relates to a battery system (200), comprising a battery cell stack (100) having a plurality of battery cells (110) and a cooling device (10).

### BACKGROUND

The present invention relates to a cooling device for cooling a battery cell stack, in particular for a motor vehicle. Furthermore, the invention relates to a battery system comprising a battery cell stack having a plurality of battery cells and a cooling device.

In the known prior art, individual battery cells are interconnected to form battery modules. Battery modules are interconnected to form batteries or battery systems. Due to the large number of different vehicle installation spaces, variable module sizes are required in order to make optimum utilization of the available installation space. Li-ion or Li-polymer battery cells heat up as a result of chemical conversion processes, especially during rapid energy delivery or absorption. The more powerful the battery pack, the greater its heating and the associated efficient active thermal management system. This allows the battery cells to be cooled and heated. Here, the battery cells have to be cooled predominantly.

The optimum operating temperature of Li-ion battery systems is approximately +5° C. to +35° C. Above an operating temperature of approximately +40° C., their service life is reduced. To achieve the service life requirement of approximately 8-10 years, sufficient thermal conditioning of the battery is therefore required. The battery cells must be kept in a thermally uncritical state below +40° C. under all operating conditions. To achieve an aging synchronization of the battery cells, the temperature gradient from battery cell to battery cell must be only slight.

Today, battery heating and cooling is mainly carried out by means of liquid temperature control with a water/glycol mixture. This is fed through channels in the cooling plates located underneath the battery modules. The cooling plates are supplied by means of cooling water hoses with corresponding additional components in the cooling circuit.

According to the prior art, inner inserts are used as turbulators in cooling plates. The disadvantage of the known channel structures with integrated turbulators is that, due to the production process, they can only be produced in certain sizes. The limits are due here to the die casting process, in which certain sizes and distances of the turbulators cannot be undershot because this cannot be produced in the die casting tool. Furthermore, the turbulators used are mostly adapted to a cooling plate or a battery system and cannot be used in a versatile way.

### SUMMARY

The invention claims a cooling device and a battery cell stack. Features described in conjunction with the cooling device according to the invention of course also apply in conjunction with the battery cell stack according to the invention and vice versa in each case, and therefore reference is or can always be made mutually with regard to the disclosure concerning the individual aspects of the invention.

According to a first aspect, the invention discloses a cooling device for cooling a battery cell stack having a plurality of battery cells, the cooling device having an inlet port for inflow of a cooling medium into the cooling device, an outlet port for outflow of the cooling medium from the cooling device, and at least one cooling channel, wherein the cooling channel is arranged in the flow path of the cooling medium between the inlet port and the outlet port, wherein at least two flow inserts are arranged in the cooling channel and the at least two flow inserts are of modular, in particular identical, and planar or substantially planar design.

The phrase “X or substantially X” is intended to be understood in the context of the invention as a possible, minor deviation, for example due to manufacturing tolerances, material and/or process properties, without changing the underlying, intended function of the feature.

A planar design of the at least two flow inserts is to be understood in the context of the invention as a main extent of the structural design of the at least two flow inserts along two spatial axes. In the third spatial axis, by way of demonstration the height of the at least two flow inserts, the extent of the at least two flow inserts is significantly smaller. With a purely hypothetical assumption of a solid design of the at least two flow inserts, the at least two flow inserts would be plate-shaped.

According to the invention, the flow inserts are designed in such a way that the flow of the cooling medium within the cooling channel is swirled by the flow inserts and the surface area for heat transfer is increased. Thus, a cooling performance of the cooling device is advantageously influenced by the flow inserts. Preferably, the flow inserts can at least partially absorb the heat from the surrounding cooling channel structure and additionally transfer it to the cooling medium. Advantageously, the modular, in particular identical design of the at least two flow inserts allows each flow insert to be inserted at any intended location in the cooling channel for a flow insert. Consequently, only one type of modular flow insert is required for a large number of differently designed cooling devices. Manufacture of the modular flow inserts and thus of the cooling devices is thus significantly simplified and reduced in cost and time. The flow inserts are preferably made of an advantageously heat-conducting metal. The modular flow inserts are preferably made of an aluminum alloy suitable for brazing, with brazing plating on both sides. Optionally, the inlet port and the outlet port are also made of an aluminum alloy and are also brazed in the same process when brazing rings are used. This saves an additional work step and results in a cost advantage. The flow inserts optimize the heat-transferring area in the cooling channel, particularly in the region of cell cooling, since the flow inserts are connected to and/or contacted with the surrounding material in a heat-transferring manner. The flow inserts are preferably used only in the region of cell cooling. The remaining regions are formed in the die-cast component described later, in particular the main body, as flow bypass regions (inflow/outflow and deflection regions), since less to no heat transfer is required here. This reduces the number of required flow inserts to a minimum, resulting in a cost advantage. A cooling device designed in this way for cooling a battery cell stack is particularly advantageous, since cooling of the battery cell stack is made possible in a particularly simple and cost-effective manner.

According to a preferred further development of the invention, it can be provided in a cooling device that the at least two flow inserts are rolled and/or stamped from a sheet metal and/or the cooling channel has a channel length and the at least two flow inserts each have an insert length, wherein the channel length corresponds to an integer multiple or substantially to an integer multiple of the insert length. The fact that the channel length corresponds to an integer multiple or substantially to an integer multiple of the insert length is to be understood in the context of the invention in such a way that, as described by way of demonstration, an integer quantity of flow inserts can be inserted and/or arranged in the cooling channel in a positionally secure manner, in particular wherein no residual length of the cooling channel remains and/or no flow inserts are arranged in a cooling channel portion. To allow for positioning devices and manufacturing tolerances described later, the cooling channel thus has a somewhat greater length in practice than an integer multiple of the insert length of a flow insert. A modular design of the flow inserts is an enormous cost and material advantage in the manufacture of cooling devices. The pitch dimension at the cell stack, i.e. the distance between two cells with a positioning device between these cells is preferably of the same order of magnitude, so that cooling with modular flow inserts is advantageously made possible. The range defined as channel length in accordance with the invention is divided, by way of demonstration, into segments so that the different systems, in particular housing lengths can be enabled by varying the number of flow inserts. Preferably, the division from flow insert to flow insert is 36.5 mm. Preferably, the length of an inlet and outlet region and of a deflection channel described later remain constant for all housing lengths. This has the advantage that the inflow and outflow of the coolant always remain the same for all housing lengths. These inflow and outflow regions and a deflection channel are not intended to be part of the cooling channel length within the scope of the invention. In the context of the invention, the cooling channel length is intended to include only the preferably straight portions for inserting and positioning the flow inserts.

According to a preferred further development of the invention, it can be provided in a cooling device that each of the at least two flow inserts comprises a plurality of flow disturbance devices, in particular wherein the at least two flow inserts each comprise undulating strips offset relative to one another, and/or that the at least two flow inserts each comprise upper and/or lower contact surfaces, in particular wherein the upper and lower contact surfaces are parallel to one another. The undulating design of the flow inserts can be of uniform or varying design. The undulations may have oblique or vertical transitions between the upper and lower contact surfaces. Preferably, a flow insert is rolled from a single piece of sheet metal. The resulting corrugated strips, which are offset relative to one another, are preferably further formed in one piece and are consequently joined to one another in an integrally bonded manner. Preferably, the flow inserts also have uniform contact surfaces at the edges, for example for an integrally bonded connection to the cooling channel. A flow insert designed in this way is particularly cost-effective and can be manufactured in a short space of time and also enables advantageous swirling of the flow in the cooling channel and an increase in the surface area for improved heat transfer to and/or from the cooling medium.

According to a preferred further development of the invention, it can be provided in a cooling device that the cooling channel comprises positioning devices for positioning the at least two flow inserts in the cooling channel. The positioning and/or orientation of the flow inserts is made possible by the positioning devices, in particular in conjunction with the structural design of the cooling channel. Before the cooling channel of the cooling device is structurally closed, the flow inserts are inserted into the cooling channel of the cooling device. For this purpose, positioning devices are provided and/or integrated on the cooling device and simplify the assembly of the flow inserts. For inner flow inserts, preferably four such positioning devices are provided per flow insert. The outer flow inserts are preferably positioned in each case via two such positioning devices and the walls of the cooling device. A distance is preferably provided between the positioning devices and the flow inserts in order to compensate for component tolerances. A cooling device designed in this way is particularly easy to manufacture, since the flow inserts can be positioned by the positioning devices using simple means with low susceptibility to error.

According to a preferred further development of the invention, it can be provided in a cooling device that the cooling device has a main body, in particular a housing, wherein the at least two flow inserts are connected to the main body in a form-fitting and/or integrally bonded manner. After the flow inserts have been inserted, as described previously, a cover element described later can be placed on or the cooling channel can be closed. The components are preferably braced together for integral bonding, in particular brazing in a furnace. The brazing results in integrally bonded connections between the contact surfaces of the cooling device on the circumferential closed edge and the cover element, and between the cover element and the flow guide contours of the cooling device. In addition, integrally bonded connections are formed between the flow insert and the cooling channel base of the cooling device and between the flow insert and the cover element. The main body is preferably designed as a die-cast housing. In particular, the main body is designed to receive the battery cell stack. In order to achieve an advantageously flat contact surface on the housing for receiving the cover element, this surface can be mechanically reworked, for example milled over. A die-casting alloy which can be brazed is preferably used for the main body. A suitable die-casting alloy is, for example, AlMn1.6 since it has the highest melting point of the aluminum die-casting alloys and is thus still solid during the brazing process with another flowable aluminum alloy and can be brazed. Preferably, the height of the modular flow inserts is slightly higher than the cooling channel height, resulting in a distance between the main body and the cover element. By deforming the flow inserts during clamping in the brazing frame to close the gap between the main body and the cover element, a secure brazing between the main body, flow inserts and cover element is achieved.

According to a preferred further development of the invention, it can be provided in a cooling device that the cooling channel is designed in a manner integrally bonded in the main body and/or the cooling channel and/or the main body are closed with a cover element, in particular wherein the cover element is connected in a form-fitting and/or integrally bonded manner to the main body and/or the at least two flow inserts. A one-piece design of the cooling channel in the main body allows particularly efficient use of installation space and thus an advantageously compact cooling device and/or battery system. The flow inserts are preferably connected in an integrally bonded manner, in particular brazed, to the main body as well as to the cover element. The cover element is preferably guided into the correct position by a positioning edge on the die-cast housing and then rests against the contact surfaces, for example in the form of brazing surfaces, on the main body. The flow inserts are preferably connected in an integrally bonded manner in the cooling channel at the base, at the edge and at the cover element. The cover element and/or the main body preferably has a poka-yoke element to prevent incorrect positioning and/or fastening of the cover element. A cooling device designed in this way allows heat to be conducted through the wall on the main body via the flow inserts into the cover element. As a result, the cover element contributes to cell cooling with its entire surface on the coolant side. The cover element is also preferably made of an aluminum alloy suitable for brazing. For this purpose, the cover element is preferably brazing-plated on one side with a suitable Al alloy. The brazing-plated side points in the direction of the die-cast housing. This is ensured, for example, by the housing element and the cover element having said poka-yoke feature. This is preferably integrated on the main body and is arranged eccentrically to the center axis. When the cover element is joined to the main body, the brazing plating then always points in the direction of the housing. The sheet thickness of the flow inserts is preferably significantly thinner than that of the cover element, in particular not more than 50, 25, 15 or 10% of the sheet thickness of the cover element, so that the flow inserts can deform during clamping and do not lead to deformation of the cover element.

According to a preferred further development of the invention, it may be provided in a cooling device that the cooling device comprises at least one deflection channel, wherein the deflection channel deflects the flow path of the cooling medium by 180° or substantially by 180°, in particular wherein the deflection channel is arranged on a first side of the cooling device and the inlet port and the outlet port are arranged on a second side of the cooling device, wherein the first side and the second side of the cooling device are arranged opposite each other. Thus, a baffle channel advantageously allows the cooling channel to be extended by simple means. By way of demonstration, the flow path of the cooling medium can be made U-shaped by a deflection channel. A large number of deflection channels are also possible, so that a serpentine flow path of the cooling medium is created. Advantageously, the inlet port and outlet port are arranged on a first side of the cooling device, and at least one deflection channel is arranged on a second, opposite side of the cooling device.

According to a preferred further development of the invention, it can be provided in a cooling device that the cooling device comprises a central separating web, wherein the separating web separates a portion of the cooling channel in the flow path upstream of the at least one deflection channel from a portion of the cooling channel in the flow path downstream of the at least one deflection channel. The portions of the cooling channel upstream and downstream of the deflection channel can also be understood as two cooling channels within the scope of the invention. Preferably, the central web is also brazed to the main body and/or to the cover element. Preferably, the separating web is formed in one part with the main body. Furthermore, it is preferred if the separating web comprises at least one positioning device described previously for positioning the flow inserts. A further optimization of the flow is realized by attaching the positioning devices to the separating web. Due to the separating web, the flow path is preferably designed as a U-flow. In this case, the cooling medium flows into and out of the cooling channel through an inlet port and an outlet port on one side of the housing. In order to avoid a direct flow (short-circuit flow) between the inlet port and outlet port, the separating web of the cooling device is preferably connected to the outer edge in an integrally bonded manner, preferably by means of brazing, to the cover element.

According to a second aspect, the invention discloses a battery system comprising a battery cell stack having a plurality of battery cells and a cooling device according to the first aspect. In the described battery system, all advantages already described with respect to the cooling device according to the first aspect of the invention are provided. The battery system preferably comprises a main body, in particular a housing. The main body of the battery system may correspond to the main body of the cooling device, so that this main body comprises and/or accommodates both devices. Preferably, the at least two flow inserts are connected to the main body in a form-fitting and/or integrally bonded manner and/or the cooling channel is formed in the main body in an integrally bonded manner, in particular wherein the cooling channel and/or the main body are closed with a cover element, in particular in an integrally bonded manner.

According to a preferred further development of the invention, it can be provided in a battery system that the battery system comprises at least one relay, wherein the at least one relay is arranged in the region of the at least one deflection channel, and/or wherein the battery cell stack is arranged in the region of the cooling channel. A relay has a lower heat and/or cooling requirement than the battery cells. A battery system designed in this way is particularly advantageous, since an advantageously sufficient heat transfer is provided for the relay in the region of the deflection channel and thus safe operation and a long service life of the relay can additionally be ensured.

### BRIEF DESCRIPTION OF THE DRAWINGS

A cooling device according to the invention and a battery system are explained in more detail below with reference to drawings, which show schematically, in each case:

FIG. 1 an exploded view, in perspective, of a cooling device having a main body, a cooling channel in the main body, a plurality of flow inserts in the cooling channel, and a cover element,

FIG. 2 a perspective view of a flow insert, and

FIG. 3 a side sectional view of a battery system with a cooling device and a battery cell stack with a plurality of battery cells.

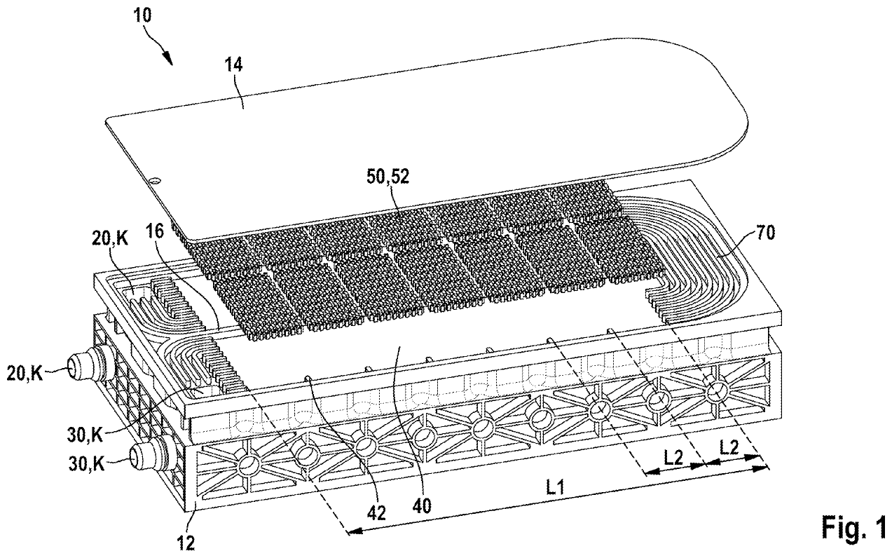

Elements with the same function and mode of operation are each provided with the same reference signs in FIGS. 1 to 3.

### DETAILED DESCRIPTION

FIG. 1 schematically shows an exploded view, in perspective, of a cooling device 10 having a main body 12, a cooling channel 40 in the main body 12, a plurality of flow inserts 50 in the cooling channel 40, and a cover element 14. The cooling device 10 has an inlet port 20 for inflow of a cooling medium K into the cooling device 10, an outlet port 30 for outflow of the cooling medium K from the cooling device 10, and two cooling channels 40. The cooling channels 40 are in the flow path of the cooling medium K between the inlet port 20 and the outlet port 30. A plurality of flow inserts 50, in this case seven in each case, are arranged in the cooling channels 40, wherein the flow inserts 50 are of modular and planar design. The flow inserts 50 are rolled and stamped from a sheet metal. Each cooling channel 40 has a channel length L1 and the flow inserts 50 each have an insert length L2, wherein the channel length L1 is substantially an integer multiple of the insert length L2. The cooling channel 40 comprises positioning devices 42 for positioning the flow inserts 50 in the cooling channel 40. The cooling device 10 has a main body 12 in the form of a housing, wherein the flow inserts 50 are connected in an integrally bonded manner to the main body 12. Due to the exploded view, the integrally bonded connection is of course not visible. The cooling channel 40 is formed in an integrally bonded manner in the main body 12, and the cooling channel 40 and the main body 12 are closed with the cover element 14, wherein the cover element 14 is connected in an integrally bonded manner to the main body 12 and the flow inserts 50. The cooling device 10 further comprises a deflection channel 70, wherein the deflection channel 70 deflects the flow path of the cooling medium K by 180°, wherein the deflection channel 70 is arranged on a first side of the cooling device 10 and the inlet port 20 and the outlet port 30 are arranged on a second side of the cooling device 10, wherein the first side and the second side of the cooling device 10 are arranged opposite each other. The cooling device 10 comprises a central separating web 16, wherein the separating web 16 separates a first cooling channel 40 in the flow path upstream of the at least one deflection channel 70 from a second cooling channel 40 in the flow path downstream of the at least one deflection channel 70.

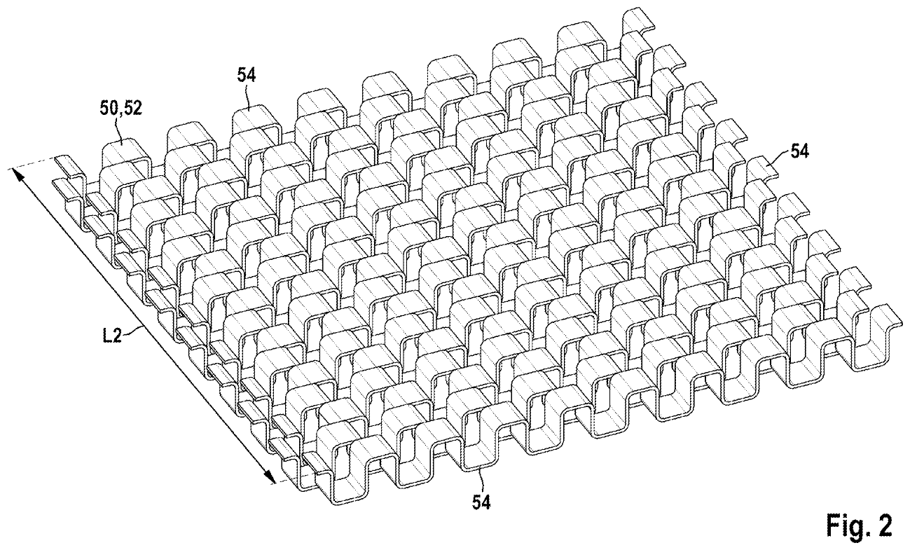

In FIG. 2, a flow insert 50 is schematically shown in a perspective view. The flow insert 50 comprises a plurality of flow disrupting devices 52, wherein the flow insert 50 consists of undulating strips offset relative to one another, and wherein the flow insert 50 comprises upper and lower contact surfaces 54, wherein the upper and lower contact surfaces 54 are parallel to one another. The undulating configuration of the flow inserts 50 is uniformly configured. The undulations have substantially vertical transitions between the upper and lower contact surfaces 54. The flow insert 50 is rolled from a single piece of sheet metal. The resulting undulating strips, which are offset relative to one another, are formed in one piece and are consequently connected to one another in an integrally bonded manner. The flow insert 50 also has uniform contact surfaces at the edges, here on the right and left, for an integrally bonded attachment to the cooling channel 40 (not shown). A flow insert 50 designed in this way is particularly cost-effective and can be manufactured in a short space time, and further allows an advantageous swirling of the flow in the cooling channel 40 (not shown) and an increase in the surface area for improved heat transfer to and/or from the cooling medium K (not shown). The flow insert 50 has an insert length L2.

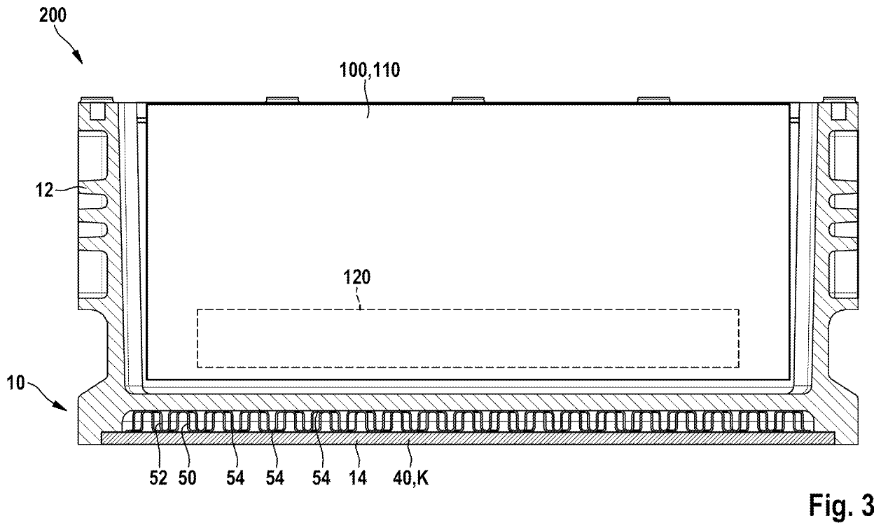

FIG. 3 shows a schematic side sectional view of a battery system 200 with a cooling device 10 and a battery cell stack 100 with a plurality of battery cells 110. The cooling device 10 is designed to cool the battery cell stack 100 having a plurality of battery cells 110. The battery system 200 further comprises a relay 120. The relay 120 is shown in a dashed manner in FIG. 3, since it is arranged behind the battery cells 110 in the image plane. The relay 120 is arranged in the region of the deflection channel 70 (not shown). The battery cell stack 100 is arranged in the region of the cooling channel 40. The relay 120 has a lower heating and/or cooling requirement than the battery cells 110. A battery system 200 designed in this manner is particularly advantageous, since advantageously sufficient heat transfer is provided for the relay 120 in the region of the deflection channel 70 (not shown), and thus safe operation and a long service life of the relay 120 can additionally be ensured. The battery system 200 has a main body 12 in the form of a housing. The main body 12 of the battery system 200 corresponds to the main body 12 of the cooling device 10, such that the main body 12 comprises and receives both devices. The flow inserts 50 are connected in an integrally bonded manner to the main body 12, and the cooling channel 40 is designed in an integrally bonded manner in the main body 12. The cooling channel 40 and the main body 12 are closed in an integrally bonded manner by the cover element 14.

1. A cooling device (10) for cooling a battery cell stack (100) having a plurality of battery cells (110), the cooling device (10) having an inlet port (20) for inflow of a cooling medium (K) into the cooling device (10), an outlet port (30) for outflow of the cooling medium (K) from the cooling device (10), and at least one cooling channel (40), wherein the cooling channel (40) is arranged in a flow path of the cooling medium (K) between the inlet port (20) and the outlet port (30),
wherein at least two flow inserts (50) are arranged in the cooling channel (40), and the at least two flow inserts (50) are modular and planar.

2. The cooling device (10) according to claim 1,
wherein the at least two flow inserts (50) are rolled and/or stamped from a sheet metal and/or
wherein the cooling channel (40) has a channel length (L1) and the at least two flow inserts (50) each have an insert length (L2), wherein the channel length (L1) corresponds to an integer multiple of the insert length (L2).

3. The cooling device (10) according to claim 1,
wherein each of the at least two flow inserts (50) comprises a plurality of flow disturbance devices (52), and/or
wherein the at least two flow inserts (50) each comprise upper and/or lower contact surfaces (54), in particular wherein the upper and lower contact surfaces (54) are parallel to one another.

4. The cooling device (10) according to claim 1,
wherein the cooling channel (40) comprises positioning devices (42) for positioning the at least two flow inserts (50) in the cooling channel (40).

5. The cooling device (10) according to claim 1,
wherein the cooling device (10) has a main body (12), wherein the at least two flow inserts (50) are connected to the main body (12) in a form-fitting and/or integrally bonded manner.

6. The cooling device (10) according to claim 5,
wherein the cooling channel (40) is designed in a manner integrally bonded in the main body (12) and/or the cooling channel (40) and/or the main body (12) are closed with a cover element (14).

7. The cooling device (10) according to claim 1,
wherein the cooling device (10) comprises at least one deflection channel (70), wherein the deflection channel (70) deflects the flow path of the cooling medium (K) by 180°.

8. The cooling device (10) according to claim 7,
wherein the cooling device (10) comprises a central separating web (16), wherein the separating web (16) separates a portion of the cooling channel (40) in the flow path upstream of the at least one deflection channel (70) from a portion of the cooling channel (40) in the flow path downstream of the at least one deflection channel (70).

9. A battery system (200) comprising a battery cell stack (100) having a plurality of battery cells (110) and a cooling device (10),
wherein the cooling device (10) is configured according to claim 1.

10. The battery system (200) according to claim 9,
wherein the battery system (200) comprises at least one relay (120), wherein the at least one relay (120) is arranged in a region of at least one deflection channel (70), and/or wherein the battery cell stack (100) is arranged in a region of a cooling channel (40).

11. The cooling device (10) according to claim 3,
wherein the plurality of flow disturbance devices (52) include undulating strips offset relative to one another on each of the at least two flow inserts (50).

12. The cooling device (10) according to claim 3,
wherein the upper and lower contact surfaces (54) are parallel to one another.

13. The cooling device (10) according to claim 5,
wherein the main body (12) is a housing.

14. The cooling device (10) according to claim 6,
wherein the cover element (14) is connected in a form-fitting and/or integrally bonded manner to the main body (12) and/or the at least two flow inserts (50).

15. The cooling device (10) according to claim 7,
wherein the deflection channel (70) is arranged on a first side of the cooling device (10) and the inlet port (20) and the outlet port (30) are arranged on a second side of the cooling device (10), wherein the first side and the second side of the cooling device (10) are arranged opposite each other.
